(19) United States
(12) Patent Application Publication
(10) Pub. No.: US 2004/0200805 A1
(43) Pub. Date: Oct. 14, 2004

(54) Metal engraving method, article, and apparatus

(76) Inventors: William Charles Ulland, Duluth, MN (US); Alexander Sergeievich Gybin, Duluth, MN (US); Jeremy W. Peterson, Superior, WI (US); David K. Sarvela, Duluth, MN (US)

Correspondence Address: Merchant & Gould P.C., P.O. Box 2903, Minneapolis, MN, 55402-0903, US

(21) Appl. No.: 10/729,620

(22) Filed: Dec. 5, 2003

Related U.S. Application Data
(60) Provisional application No. 60/431,328, filed on Dec. 6, 2002.

(51) Int. Cl. B44C 1/22

(52) U.S. Cl. 216/89

(57) ABSTRACT

The present invention is directed to metal articles and methods of making the metal articles. The metal articles comprise a compression-formed particulate metal object, wherein a portion of the compression-formed particulate metal object has been selectively removed by an etching process from at least one surface of the object. The etching process is frequently performed using abrasive etching.

### FIELD OF THE INVENTION

The present invention is directed to the field of metal objects incorporating an image, including metal objects subject to abrasive etching.

### BACKGROUND

Imaged metal articles, such as acid-etched metal panels used in the signage industry, are popular for their durability and attractiveness. Such imaged metal articles are often formed by using a strong acid to selectively remove part of the solid metal, resulting in multi-dimensional article. The action of the acid is controlled by using an acid resistant material, such as a wax mask, deposited onto the metal article prior to etching. Unfortunately, many metal objects are relatively hard to etch, and even acid etching can be very time consuming. In addition, acid etching requires the use of hazardous materials and offers relatively little opportunity to vary the depth of etching across an article without cumbersome multi-etching processes. Also, acid action is non-directional, resulting in the mask frequently being undercut during the etching process. This can be a very significant problem, particularly when a high level of detail is desired.

It is also possible to create an imaged metal article by casting using molten metals. However, such images require the making of a mold to receive the molten metals, and production of such molds is often a challenging and expensive task. In addition, working with molten metals requires significant capital inputs for the furnaces to heat the metal and the equipment to cast it. Metal casting is also often quite hazardous.

Metal images can also be formed, in some circumstances, by traditional mechanical milling techniques, including CNC machining. Although such techniques can often produce very detailed, complex images, a large capital outlay is required for the equipment and operation can be relatively expensive.

Therefore, a need exists for an improved method for making imaged metal articles.

### SUMMARY OF THE INVENTION

The present invention is directed to a method of creating an image in metals, typically by creating an image in a article or object formed of particulate metals, such as powdered metals that have been formed into a rigid object. In particular, the invention is directed to a method of creating an image in a substantially rigid compressed particulate metal object. The particulate metal object can be an unsintered compressed particulate metal (hereafter called “green” materials), or a partially sintered compressed metal. The partially sintered metal is compressed particulate metal that has been heated (optionally in a reductive atmosphere) sufficiently to create some bonding between the metal particles, but significantly less bonding than if the metal had been heated high enough to fully sinter such as to form such strong bonds between particles that the material is not readily etchable. The image can be formed by abrasive etching of the metal using a photoresist film or mask as a stencil.

An important advantage of the present invention is that the green or partially sintered metals are strong enough to be handled, moved, and processed; yet are not so ductile that they cannot be easily etched using an abrasive or other mechanical process to remove excess metal. As used herein, etching refers to the ability to selectively remove portions of a material, such as by abrasive blasting and other techniques described throughout the specification. Thus, the green or partially sintered metals can be abrasively etched relatively easily because they are much more brittle than similar solid materials containing the same metals, yet they can be subsequently fully sintered to become much stronger without losing their etched surface.

After etching, the metal object can be further treated by partially or completely sintering it, impregnating it with a plastic or other organic material, infiltrating with a liquid metal, or other processing. As used herein, impregnation includes filling the pores of a sintered, partially sintered or unsintered, powder metal compact with a nonmetallic material such as an organic binder to increase strength, durability and adhesion of mask material. The nonmetallic material is referred to herein as an impregnant. As used herein, infiltration is a process of filling the pores of a sintered, partially sintered or unsintered, powder metal compact with a metal or alloy of lower melting point than base metal to increase strength, durability, adhesion of mask material and to improve appearance. The metal or alloy is referred to herein as an infiltrate. Also, significant benefits in appearance can be obtained by brushing the exposed surfaces of the metal to conceal any visible voids in the metal object. Once etched and any additional finishing steps have been performed, the etched metal object can be used for many different purposes, including use as a decorative object, use as a mold, use as a printing plate, use as an embossing die, etc. A further coating or plating step can be used to improve hardness or appearance of the etched metal.

A preferred method of engraving or etching the metal object is by particulate blasting (also referred to as abrasive etching) such as particulate blasting using, for example, silicon carbide or aluminum oxide, often using a stencil. The stencil can be a photoresist film (such as ImagePro Red™ made by The Ikonics Corporation (formerly the Chromaline Company) of Duluth, Minn.). The film may be imaged and developed either separately from the metal object or, in some implementations, on the metal object. A liquid photoresist, such as SBX™ made by Ikonics, can be coated on the green or partially sintered metal. In this case, a layer can be added to the metal object to keep the liquid from soaking into the particulate metal material and to improve adhesion. Alternatively, in some implementations, a standard vinyl stencil can be used.

In a further enhancement of the invention, multi-layer articles can be formed using one or more particulate metal layers along with one or more other layers. For example, in one embodiment, the articles include a first layer of particulate metal suitable for etching along with a second layer of etch resistant material that controls depth of etching of the articles. This bottom layer is resistant to etching using abrasives, and helps to promote a uniform etching depth, to control blast depth, add strength, and provide visual contrast.

Further aspects of the invention will now be described by reference to the figures and detailed description that follows.

### FIGURES

Other aspects and advantages of the invention will become apparent upon reading the following detailed description and upon reference to the drawings in which:

FIG. 1 is a photograph of an article made in accordance with the present invention.

FIG. 2A is a simplified side elevational view of a first metal object made in accordance with the invention, showing the object and a mask.

FIG. 2B is a simplified side elevational view of the metal object of FIG. 2A, showing the object along with a mask after removal of unmasked metal.

FIG. 2C is a simplified side elevational view of the metal object of FIG. 2B, showing the object after removal of the mask.

FIG. 3A is a simplified side elevational view of an article made in accordance with the present invention, the article containing two layers, only one of which is a particulate metal composition.

FIG. 3B is a simplified side elevational view the article FIG. 3A, showing the article after etching.

FIG. 4A is a simplified side elevational view of an article made in accordance with the present invention, the article containing two layers, only one of which is a particulate metal composition.

FIG. 4B is a simplified side elevational view the article FIG. 4A, showing the article after etching.

While the invention is susceptible to various modifications and alternative forms, specifics thereof have been shown by way of example in the figures and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed to a method of creating an image in metals, typically by creating an image in a object of particulate metals, generally a object of compression-formed particulate metals. The particulate metal articles are subsequently modified by removing a portion of the particulate metal to create an image within the article.

The removed portion of particulate metal can be removed, for example, by abrasive etching of the metal using a photoresist film or mask as a stencil along with sandblasting equipment. The etched metal can be processed in the following ways. First, the porous material can be infiltrated with a free-flowing hot liquid metal or metal alloy to create strength and durability. Alternatively, the material can be impregnated with a plastic, epoxy or a similar chemical to create strength and durability. Also, the material can be sintered to create strength and durability and then may be infiltrated or impregnated. As used herein, sintering includes metallurgical bonding of particles in a powder mass or compact resulting from a thermal treatment at a temperature below the melting point of the main constituent.

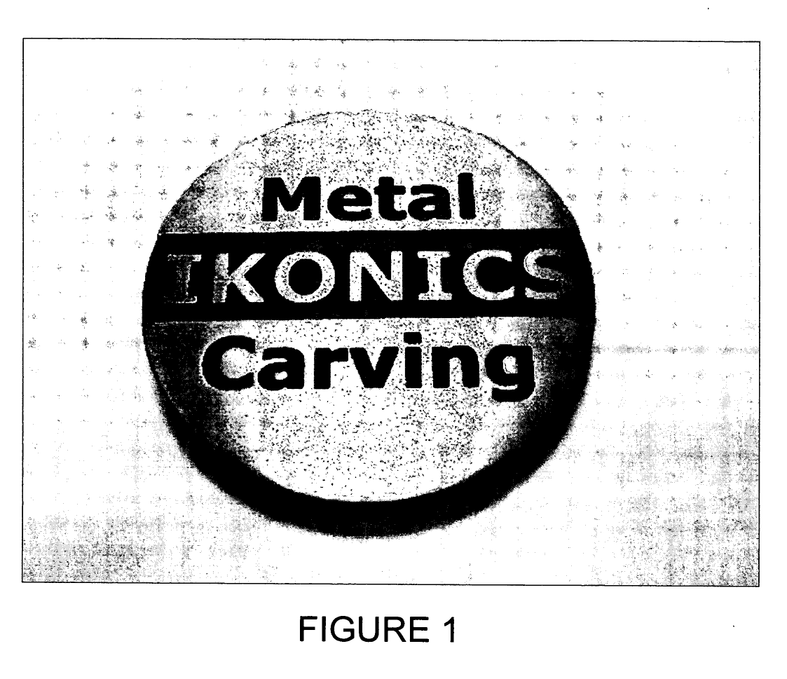

An example of an imaged metal article made in accordance with the invention is shown in FIG. 1, which is a photograph of compressed brass particles that have subsequently been etched using a photoresist mask and a stream of abrasive particles to reveal the word “Ikonics”.

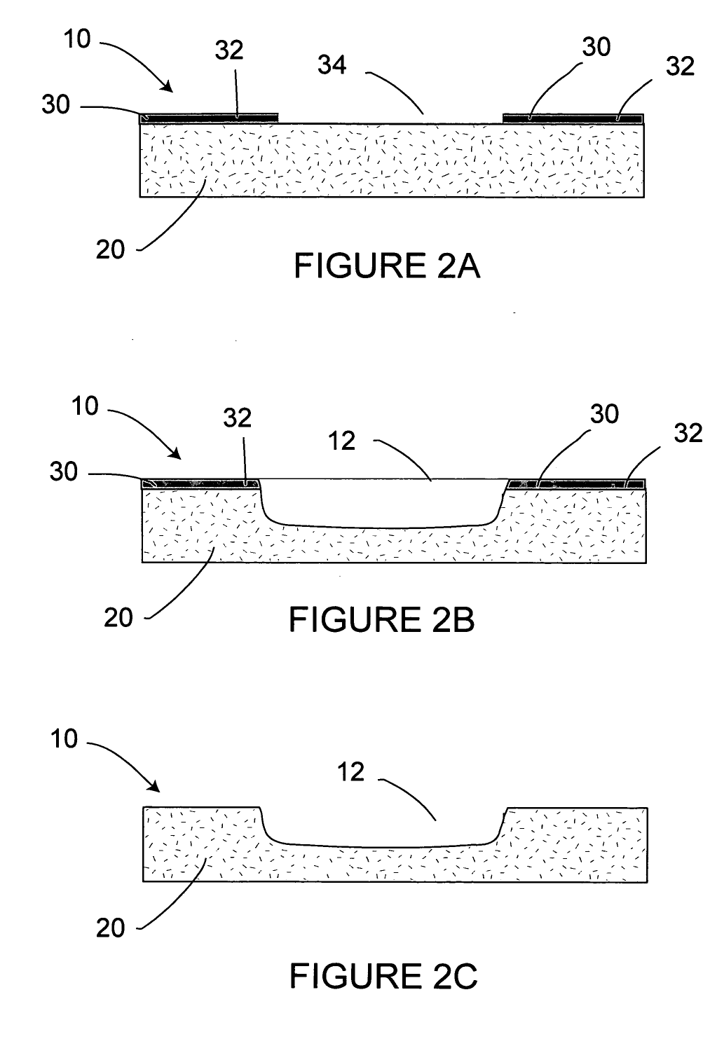

Formation of an imaged metal object such as that shown in FIG. 1 is depicted in series in FIGS. 2A, 2B, and 2C, which are simplified cross-sectional representations of an article made in accordance with the present invention. In FIG. 2A, the article 10 includes a metal object 20 containing metal particles compressed together to become substantially rigid, along with a developed photoresist mask 30 containing intact areas 32 that cover portions of the metal object 20, along with removed areas 34 that expose the metal object 20. The article 10 of FIG. 2A can be abraded or etched using sandblasting equipment to remove portions 12 of the metal object 20, those removed portions 12 corresponding to the areas that were not covered by the photoresist mask 30. In FIG. 2C the article 10 of FIG. 2B is shown once the remaining photoresist mask has been removed, giving a finished article much as that shown in FIG. 1. Additional processing steps, described below, may also be performed on the article 10 of FIG. 2C.

Further aspects of the invention, including the metal object, the metal removing process, and the use of multi-layer articles, will now be described in greater detail.

Metal Objects Made Using the Invention

The invention is directed, in a first part, to a metal object that is easily workable using various etching and engraving processes, including abrasive etching. The metal object is formed of small metal particles, often particles small enough to create a metal powder. These particles are typically no larger than 1 millimeter diameter, more typically no larger than 250 micrometers, and sometimes no larger 150 micrometers. However, it will be appreciated that in some implementations some of the metal particles will be outside of these size ranges. Various metal particles may be used with the invention, including (for example) iron, stainless steel, aluminum, nickel, magnesium, brass, bronze, copper, tin, zinc, lead, and combinations and alloys thereof.

The metal particles are generally formed into a rigid object under high pressure to reduce voids between the particles and to form a relatively rigid object. Suitable pressure will vary depending upon the material being used, the size of the particles, and the desired features of the finished article. In most implementations the pressure on the metal particles during formation of the metal object will exceed 10 tons per square inch, and usually exceed 25 tons per square inch. In most implementations this pressure will be from about 20 to 50 tons per square inch, more commonly from about 25 to 45 tons per square inch, and frequently from 30 to 35 tons per square inch. The pressure can be applied using a conventional piston or mechanical press using cams to make individual objects or using a roll press to form a continuous object. Other compression methods are possible, including explosive compression and isostatic presses.

The size of the object will often be dictated by the equipment used to manufacture it. Piston-pressed objects can be made in various sizes, commonly less than 100 square inches, often less than 50 square inches, and frequently less than 20 square inches. Roll-pressed objects can be much larger, and are particularly well suited to making large articles, such as signs.

Conventional compression forming of metal particles in a piston press usually includes mixing a lubricant with the metal powder prior to compression forming. Such lubricants are acceptable in some implementations of the invention, but are not desirable in other implementations because the lubricant is retained in the metal article, lessening interconnected porosity altering internal surface characteristics, thereby making it harder to impregnate the metal with a impregnant or infiltrate it with another metal. In such implementations it is possible to coat only the walls of the die used in the press, without adding any (or adding less than traditional) lubricant to the powdered metal itself.

The metal particles are formed into a rigid or substantially rigid object, generally by compressing under very high pressures. In a first implementation, the metal particles are formed into an object under pressure, typically at least 10 tons per square inch. The resulting object has a density of at least 50 percent of the density of the solid metal forming the particulate metal composition. More typically the metal-containing object has a density of at least 70 percent of the density of the solid metal forming the particulate metal composition, at least 80 percent in other embodiments, and at least 90 percent of the solid metal in yet other embodiments. The relatively high density of the object gives it a weight and conductivity approaching that of solid metal, and also reduces voids between the particles, thereby also increasing the similarity in appearance to solid metal. Special formulations and degrees of compression can be created to give different appearances, hardnesses, blast resistance, impregnation susceptibility, and infiltration susceptibility.

In a first implementation, once the object has been formed, such as by compression molding, then it is ready to be etched, such as by abrasive removal of portions of the object. Thus, in some implementations the object requires no further processing before etching. However, in other implementations the metal is first partially sintered by raising it to an elevated temperature at which the particulate metal composition is partially fused sufficiently that the individual particles adhere more strongly to one another, thereby creating a stronger object. Caution should be taken to assure that the object is not heated so highly as to prevent readily being etched. In other implementations the green or partially sintered object is impregnated and then etched. Adding the impregnant can improve strength of the object and improve adhesion of photoresist masks, while still being etchable. Also, the addition of an impregnant can improve durability and add resistance to corrosion by limiting the surface area of exposed metal.

An important advantage of certain implementations of the present invention is that the green or partially sintered metals are strong enough to be handled, moved, and processed; yet can be readily etched using an abrasive. Thus, the green or partially sintered metals can be abrasively etched relatively easily because they are much weaker than similar solid materials containing the same metals, yet they can be subsequently fully sintered to become much stronger without losing their etched surface.

Metal Removal and Further Processing

Once the particulate metal object has been formed, it can be imaged using various processes, including abrasive etching, water machining using water jets without an abrasive, water machining using water jets with an abrasive, ultrasonic machining, laser machining, and traditional machine milling with manually controlled or computer controlled mills.

One desirable etching method is the use of stencils formed from a photoresist film along with particulate abrasives. The photoresist film is formed into a stencil by controlled exposure to light. The film can be exposed while positioned on the metal object, or alternatively can be exposed separately and then later applied to the metal object. If development of the film is necessary, this may be done before applying to the object or development may occur while the film is secured to the object. In some embodiments, the film is self-adhesive and adheres readily to the metal. If it is not self-adhesive, the mask or film or the metal object can be sprayed or brushed with an adhesive. The object is then abrasively blasted with sand or a similar material.

Also, a liquid photoresist, such as SBX product made by The Ikonics Corporation (formerly the Chromaline Corporation) of Duluth, Minn., can be coated on the green or partially sintered metal. In this case, a layer can be added to the object to keep the liquid from soaking into the particulate metal material and to improve adhesion. Alternatively, in some implementations, a standard vinyl stencil can be used.

After etching, the metal can then be further treated by sintering, impregnating with a plastic, infiltrating with a liquid metal, electroplating, painting, or other processing. Also, the further coating or plating step can be used to improve hardness or appearance of the etched metal.

Etching of the compressed particulate metal of the present invention is a significant advantage over prior methods of making imaged metals, such as acid etching, because it can produce superior results, is easier to perform, does not involve hazardous or dangerous chemicals, and has a relatively low capital investment for end-users who will be imaging pre-formed objects containing the compression formed particulate metals. The methods are particularly well suited to implementations that use photomasks, which are sufficiently durable to etch the metal objects of the invention, even though they generally do not have adequate durability for etching many solid metals.

Multi-Layer Objects

The invention is also directed to multi-layer articles that have one or more layers of etchable particulate metal along with additional layers that can be either etch resistant or easily etched. The additional layer can be, for example, a backing to the particulate metals that is etch resistant. This etch resistant backing is useful in controlling the depth of the etching process. This backing can help promote a uniform etching depth, add strength, and improve visual contrast. Suitable materials for this include solid metals, rubber, plastic, and etcetera.

In the alternative, an etchable cover layer can be place over the particulate metal for improved ornamental appearance or as a protective layer. This layer can be, for example, a very thin metal layer of the same material used to form the particulate metal layer.

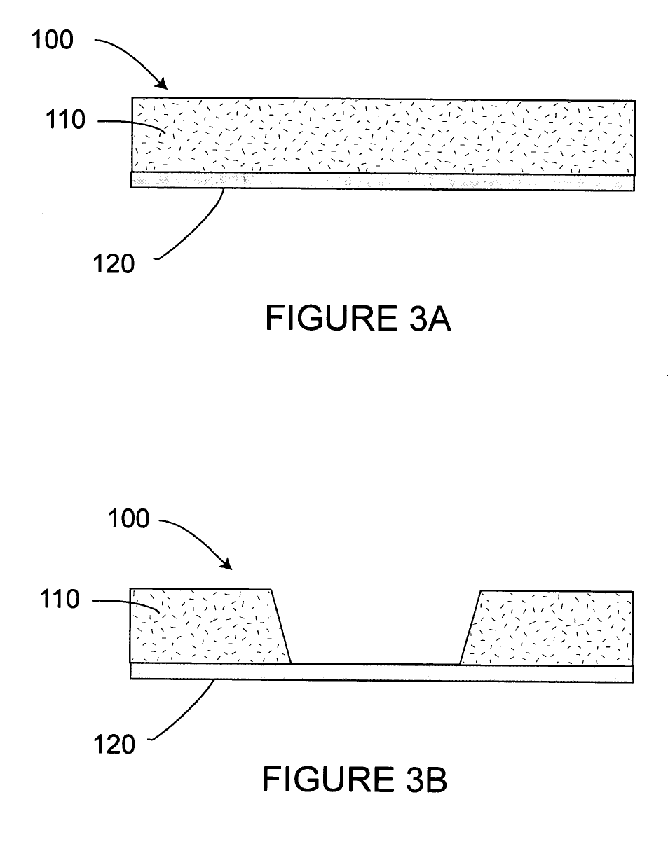

One such article is a multi-layer object comprising a compression-formed green or partially sintered particulate metal layer, the particulate metal layer formed by pressing a substantially free-flowing particulate material under sufficient pressure such that it forms a substantially rigid sheet, the rigid sheet being readily etchable by abrasive etching, and an etch-resistant layer adjacent to the particulate metal layer, the etch-resistant layer having at least twice the resistance to abrasive etching as the compression-formed green or partially sintered particulate metal layer. In reference now to FIGS. 3A and 3B, a metal object having two layers is shown. The object 100 has a first layer 110 containing compression-molded particulate metal that is readily etchable, along with a second layer 120 behind the first layer, this second layer being etch resistant, such as a solid metal plate. In FIG. 3A the two layers are shown intact and before any etching has occurred. In FIG. 3B portions of the first layer 110 have been etched away, exposing the second layer 120. Using materials such as those shown in FIGS. 3A and 3B it is possible to create images in which the removed portion has a substantially uniform depth. The metal-containing object may be secured to a second layer after compression forming of the object, said second layer providing a backing for the metal containing object.

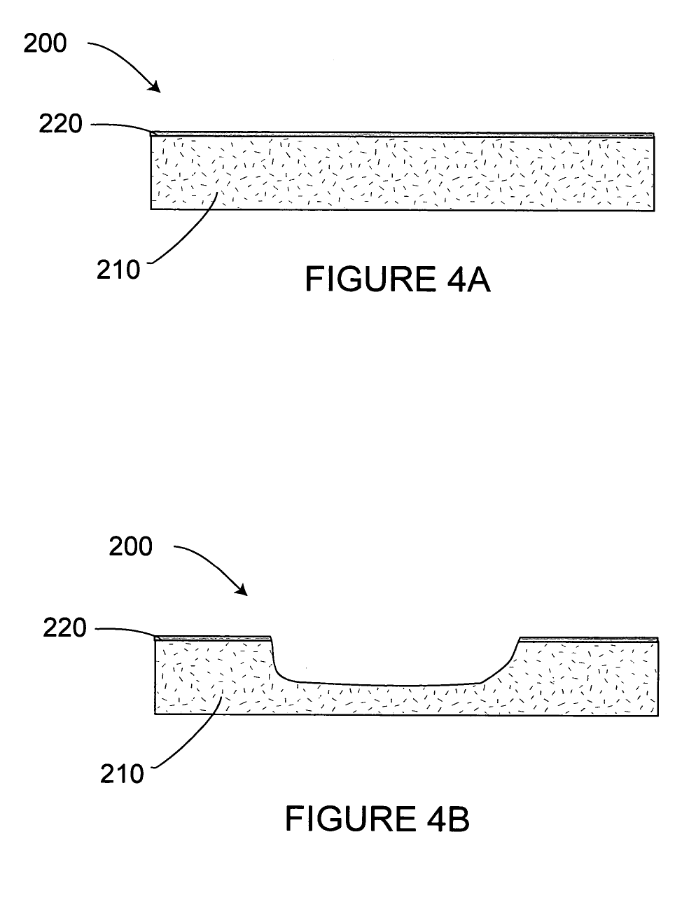

In some implementations the metal-containing object is secured to a second layer after compression forming of the object, said second layer providing a cover layer for the metal containing object. This cover layer is optionally removable by etching. An example of such metal-containing objects is shown in FIGS. 4A and 4B, both of which show an object 200 having two layers. A first layer 210 is formed of compression-molded particulate metal, and is readily etchable. The second layer 220 is also readily etchable, but is non-particulate. This second layer can be, for example, a very thin layer of metal, a layer of paint, etc.

Applications

The present invention is directed, in part, to a method of making an imaged metal object. Metal objects made in accordance with the present invention can be used for numerous different applications, including in signage, awards, plaques, molds, machined goods and prototypes. Images created using the method and article of the invention may be letters, numbers, plaques, stamping dies, embossing dies, printing plates, or numerous other articles. The metal material may be stage carved to give a shaped surface for embossing or other applications. In such implementations, very deep engraving may be done to create three-dimensional objects out of the green or partially sintered material.

Other embodiments of the invention will be apparent to those skilled in the art from consideration of the specification and practice of the invention disclosed herein. It is intended that the specification and examples be considered as exemplary only, with a full scope and spirit of the invention being indicated by the following claims.

We claim:

1. An etched metal article, the metal article comprising:
a compression-formed particulate metal object;
wherein a portion of the compression-formed particulate metal object has been selectively removed by an abrasive etching process from at least one surface of the object.

2. The etched metal article of claim 1, wherein the object further comprises an impregnant contacting at least a portion of the metal particles in the compression-formed particulate metal object.

3. The etched metal article of claim 1, wherein the metal particles are selected from the group iron, stainless steel, aluminum, nickel, magnesium, brass, bronze, copper, tin, zinc, lead, and alloys and combinations thereof.

4. The etched metal article of claim 1, wherein the compression-formed particulate-metal object is impregnated with an impregnant liquid prior to etching.

5. The etched metal article of claim 1, wherein the compression-formed particulate-metal object is partially sintered prior to etching and is impregnated with an impregnant liquid after being partially sintered but before being etched.

6. The etched metal article of claim 1, wherein the article further comprises a non-particulate object, the non-particulate object joined to the particulate metal object prior to etching of the particulate metal object

7. The etched metal article of claim 1, wherein the article further comprises an etch resistant object, the etch-resistant object joined to the particulate metal object prior to etching of the particulate metal object;
wherein the etch resistant object is significantly more etch resistant than the particulate metal object.

8. The etched metal article of claim 1, wherein the article further comprises an etch resistant object, the etch-resistant object joined to the particulate metal object prior to etching of the particulate metal object;
wherein the etch resistant object is at least 50 percent more etch resistant than the particulate metal object to etching with particulate abrasives.

9. The etched metal article of claim 1, wherein the metal particles are at least partially sintered before abrasive etching of the object.

10. The etched metal article of claim 1, wherein the metal particles are at least partially sintered after abrasive etching of the object.

11. The etched metal article of claim 1, wherein the metal object is infiltrated with a molten metal.

12. The etched metal article of claim 1, wherein the object has a density at least 85 percent of the solid metal comprising the metal particles.

13. The etched metal article of claim 1, wherein the object has a density at least 80 percent density of the solid metal comprising the metal particles.

14. The etched metal article of claim 1, wherein the object has a density at least 70 percent density of the solid metal comprising the metal particles.

15. The etched metal article of claim 1, wherein the object has a density of at least 60 percent density of the solid metal forming the metal particles.

16. The etched metal article of claim 1, wherein the object has a density of at least 50 percent density of the solid metal forming the metal particles.

17. A method of making an imaged metal object, the method comprising:
providing a particulate metal composition;
compressing the particulate metal composition such that the particulate metal composition forms a metal-containing object, the object having a density of between 60 and 90 percent of the density of the metal forming the particulate metal composition; and
abrasively etching a image into the particulate metal composition so as to remove a portion of the object.

18. The method of claim 17, further comprising impregnating the object with a non-metallic composition before or after abrasively etching an image.

19. The method of claim 17, further comprising providing a mask over a portion of the metal-containing object so as to form a selectively etchable object.

20. The method of claim 17, further comprising at least partially sintering the metal metal-containing object before or after etching.

21. The method of claim 17, further comprising impregnating the metal-containing object after sintering but before etching.

22. The method of claim 20, wherein the particulate metal composition is at least partially sintered after etching the image into the object.

23. The method of claim 20, wherein the particulate metal composition is at least partially sintered before etching the image into the object.

24. The method of claim 17, wherein the metal-containing object has a density of at least 70 percent of the density of the solid metal forming the particulate metal composition.

25. The method of claim 17, wherein the metal-containing object has a density of at least 80 percent of the density of the solid metal forming the particulate metal composition.

26. The method of claim 17, wherein the metal-containing object is secured to a second layer after compression forming of the object, said second layer providing a backing for the metal containing object.

27. The method of claim 17, wherein the metal-containing object is secured to a second layer after compression forming of the object, said second layer providing a cover layer for the metal containing object.

28. The method of claim 27, wherein the cover layer is removable by etching.

29. The method of claim 17, wherein the metal object is compression formed by a roll press.

30. The method of claim 17, wherein the metal object is compression formed by a piston press.

31. An etched metal article, the metal article comprising:
a multi-layer object comprising:
a) a compression-formed particulate metal layer, the particulate metal layer formed by pressing a substantially free-flowing particulate material under sufficient pressure such that it forms a substantially rigid sheet and impregnating the sheet with an impregnant such that the rigid sheet is readily etchable by abrasive etching, and
b) an etch-resistant layer in contact, or near contact, with the particulate metal layer, the etch-resistant layer having at least twice the resistance to abrasive etching as the compression-formed particulate metal layer;
wherein a portion of the compression-formed particulate metal layer has been selectively removed to expose the etch-resistant layer

32. The etched metal article of claim 31, wherein the etch-resistant layer comprises a solid metal object.

33. The etched metal article of claim 31, wherein the portion of the compression-formed particulate metal layer is selectively removed by using a photosensitive mask.

34. The etched metal article of claim 31, wherein the compression-formed particulate metal layer is partially sintered before being impregnated.
